(19) United States
(12) Patent Application Publication
(10) Pub. No.: US 2018/0372324 A1
(43) Pub. Date: Dec. 27, 2018

(54) PORTABLE FIRE RING

(71) Applicant: John J. Gamble, Port Orange, FL (US)

(72) Inventor: John J. Gamble, Port Orange, FL (US)

(21) Appl. No.: 15/631,369

(22) Filed: Jun. 23, 2017

(51) Int. Cl. F24B 1/192; F24B 1/181

(52) U.S. Cl. CPC F24B 1/192; A47J 37/07; F24B 1/181

(57) ABSTRACT

A portable fire ring is provided. The portable fire ring includes a plurality of plate sections which are secured together in an end-to-end relationship to form or fold into various geometrically shaped operably configured fire rings. The plurality of plate sections includes first and second end plate sections couplable to the remaining plate sections to close the desired geometric shape. Each plate section is connected end to end to an adjacent plate section so that the portable fire ring is moveable or foldable between the various operable configurations and a storage configuration.

### BACKGROUND OF THE INVENTION

The present invention relates to fire rings and, more particularly, to a portable fire ring movable between a storage configuration and an operable configuration for surrounding a campfire.

Usually campers start a campfire in a fire pit or surround the campfire with rocks in order to keep the fire from spreading. When there is no fire pit nor sufficient amount or quality of rocks, a fire ring is useful. Fire rings, however, tend to be large, heavy and rather clunky to transport and store, especially considering campers tend to have limited storage space and prefer to keep their load as light as possible. Also, although there are some lighter weight fire pits, but they tend to melt because of their lightweight material.

As can be seen, there is a need for a portable fire ring movable between a storage configuration that fits into a small box and an operable configuration for surrounding a campfire.

### SUMMARY OF THE INVENTION

In one aspect of the present invention, a portable fire ring including at least two substantially identical member plate sections, each member plate section having a member body defined by a member upper edge, a member lower edge and opposing member ends, each member end providing a member rod having opposing termini extending beyond the member upper and lower edges, respectively; and a plurality of connectors providing at least two spaced apart holes, each hole dimensioned to snugly, removably and slidably receive a terminus therethrough, whereby the member rods rotatably engage respective holes so that the portable fire ring is foldable between an operable configuration and a storage configuration wherein the member bodies are coextensively stacked.

In another aspect of the present invention, a portable fire ring system includes a portable fire ring providing: at least two substantially identical member plate sections, each member plate section having a member body defined by a member upper edge, a member lower edge and opposing member ends, each member end providing a member rod having opposing termini extending beyond the member upper and lower edges, respectively; a first end plate section having a first body defined by a first upper edge, a first lower edge and opposing first rod end and sleeve ends, the first rod end providing a first rod having opposing termini extending beyond the first upper and lower edges, the sleeve end providing at least one first sleeve; a second end plate section having a second body defined by a second upper edge, a second lower edge and opposing second rod end and sleeve ends, the second rod end providing a second rod having opposing termini extending beyond the second upper and lower edges, the second sleeve end providing at least one second sleeve, wherein the at least first and second sleeves are aligned and spaced apart in the operable configuration; a plurality of connectors providing at least two spaced apart holes, each hole dimensioned to snugly, removably and slidably receive a terminus therethrough, wherein each rod rotatably engages the respective hole so that the portable fire ring is foldable between an operable configuration and a storage configuration wherein the member bodies are coextensively stacked; and a connecting rod dimensioned to removably be received through the at least first and second sleeves in the operable configuration; and a storage box dimensioned to snugly receive the storage configuration.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in an exemplary operable configuration/arrangement;

FIG. 2 is a detail exploded view of an exemplary embodiment of the present invention;

FIG. 3 is a section view of an exemplary embodiment of the present invention, taken along line 3-3 of FIG. 1, illustrating the movement of the plates;

FIG. 4 is a perspective view of an exemplary embodiment of the present invention, shown in the storage configuration/arrangement

FIG. 5 is a perspective view of an exemplary embodiment of the present invention, illustrating a stored condition;

FIG. 6 is a perspective view of an exemplary embodiment of the present invention, shown in an exemplary operable configuration; and

FIG. 7 is a perspective view of an exemplary embodiment of the present invention, shown in an exemplary operable configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a portable fire ring providing a plurality of plate sections which are secured together in an end-to-end relationship to form or fold into various geometrically shaped operably configured fire rings. The plurality of plate sections includes first and second end plate sections couplable to the remaining plate sections to close the desired geometric shape. Each plate section is connected end to end to an adjacent plate section so that the portable fire ring is moveable or foldable between the various operable configurations and a storage configuration.

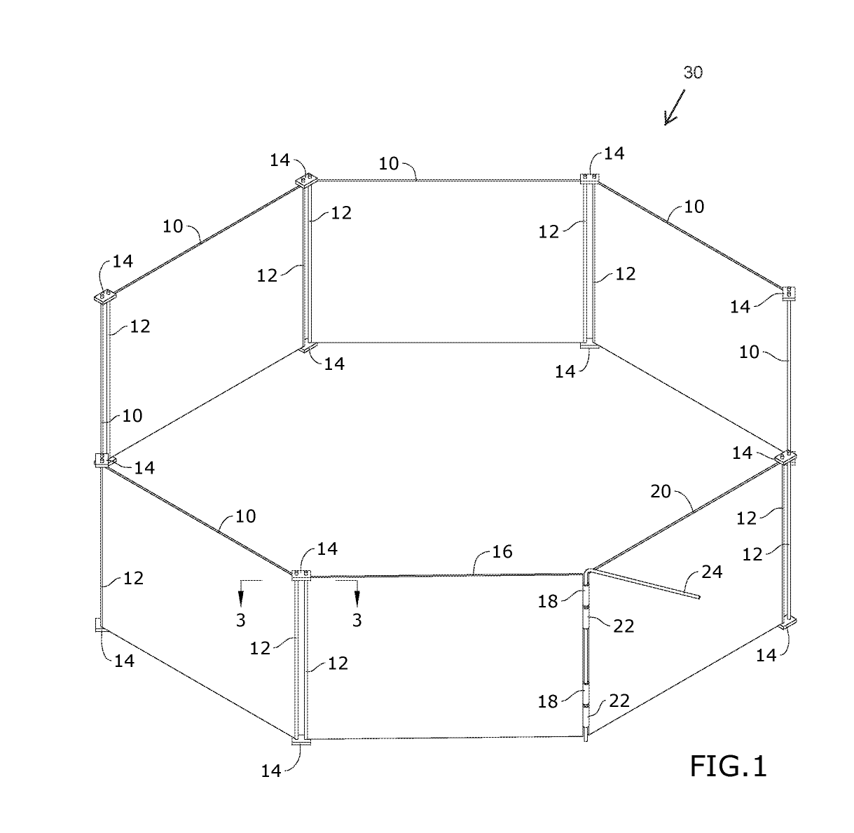

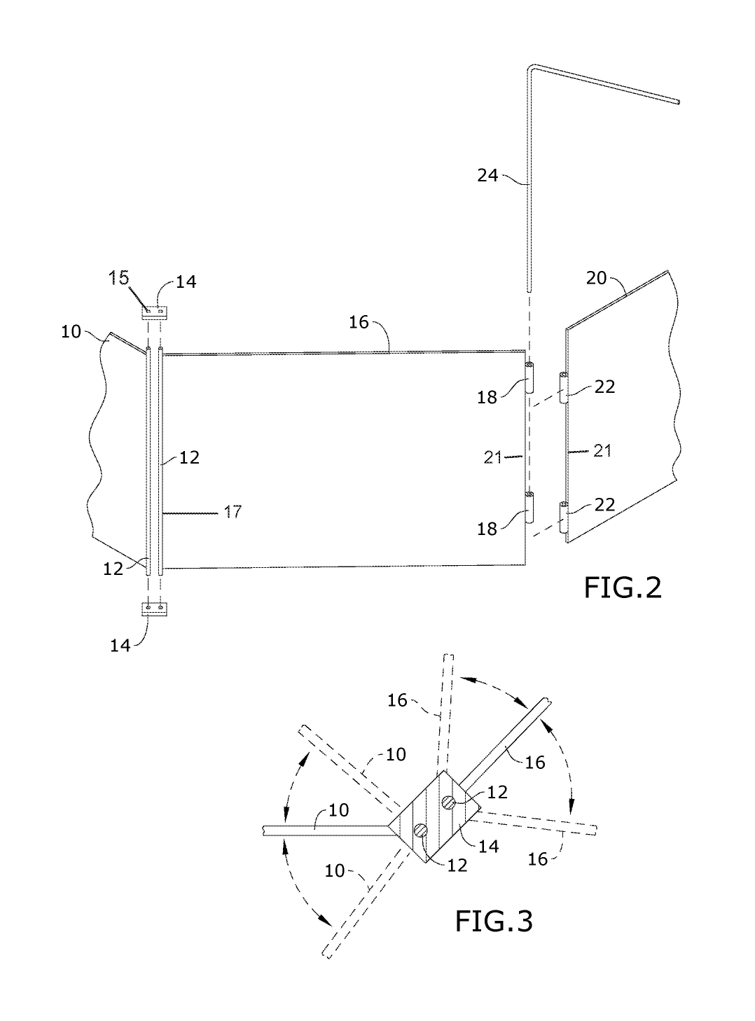

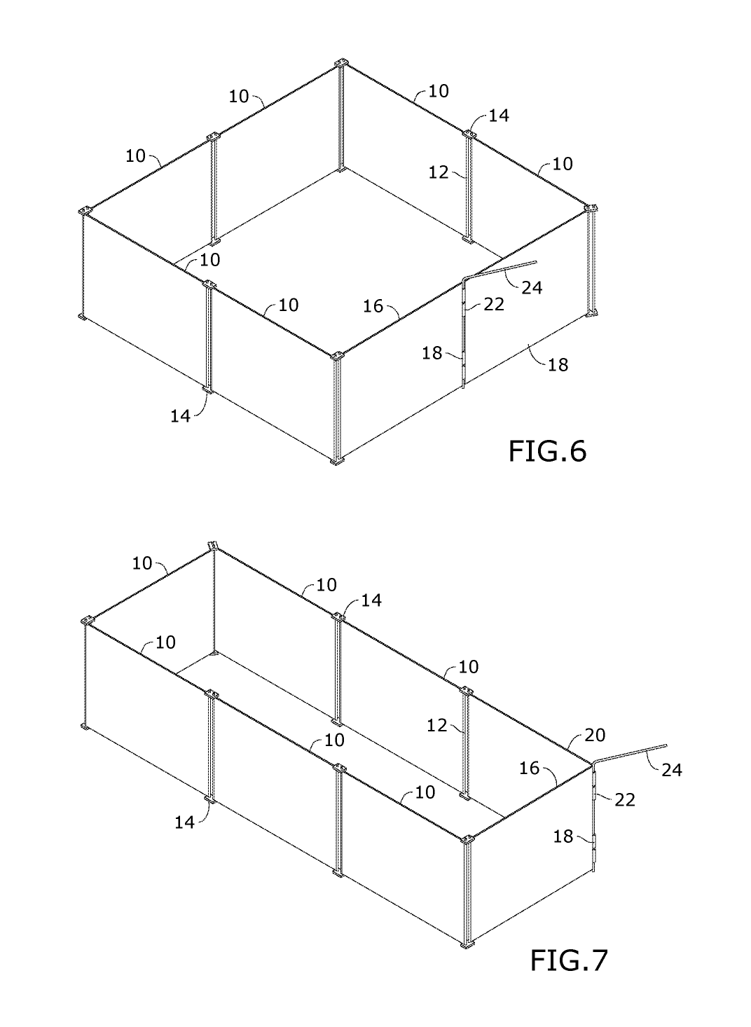

Referring to FIGS. 1 through 7, the present invention may include a portable fire ring 30 providing a plurality of plate sections 10, 16 and 20 which are secured together in an end-to-end relationship to form or fold into various geometrically shaped fire rings. The plurality of plate sections may include member plate sections 10 couplable to a first end plate section 16 and a second end plate section 20. Each plate section 10, 16, and 20 may be stainless steel or made from other suitably sturdy, durable, fire-resistant materiel.

Each member plate section 10 may have a body defined by an upper edge, a lower edge and opposing ends. Each end provides a rod 12 attached thereto, so that the opposing termini of each rod 12 protrudes above/beyond the upper and lower edges of the associated plate section 10, as illustrated in the Figures.

The present invention provides a plurality of rod connectors 14 adapted to simultaneously engage two adjacent rods 12 of two adjacent plate sections 10, 16, and/or 20. Each rod connector 14 provides at least two spaced apart holes 15 for such engagement. Each hole 15 may be dimensioned and adapted to removably/slidably receive the terminus of a rod 12 therethrough, wherein such an engaged rod 14 may still rotate within said hole 15, whereby its associated plate section my fold or rotate relative to said adjacent plate section, as illustrated in FIG. 3. Thereby, different geometric shapes can be formed from the plurality of member plate sections 10 as illustrated in FIGS. 1, 6 and 7.

Each end plate section 16 and 20 also has a body defined by an upper edge, a lower edge and a rod end 17 and an opposing sleeve end 21. The rod end 17 provides a rod 12 attached there along, so that the opposing termini of each rod 12 protrudes above/beyond the upper and lower edges of the associated plate section 16 or 20. The sleeve end 21 may provide at least two aligned, spaced apart sleeves 18 or 22, wherein the sleeves 18 and 22 may be akin to hinge knuckles. The first end plate section 16 may provide the first sleeves 18 and the second end plate section 20 may provide the second sleeves 22, wherein the first and second sleeves 18 and 22 are staggered relative to each other so that when the respective sleeve ends 21 are place in an adjacent or abutting condition, the lumens of the first and second sleeves 18 and 22 align so that a connecting rod 24 may slide through all the first and second sleeves 18 and 22. The connector rod 24 may be L-shaped to facilitate its manipulation, wherein one leg of the L-shape is received in the first and second sleeves 18 and 22, while the other perpendicular leg can be manually handled and operated, for example for dragging the fire ring 30 in the operable configuration. While received within the first and second sleeves 18 and 22, the connector rod 24 is rotatable, further facilitating its operability.

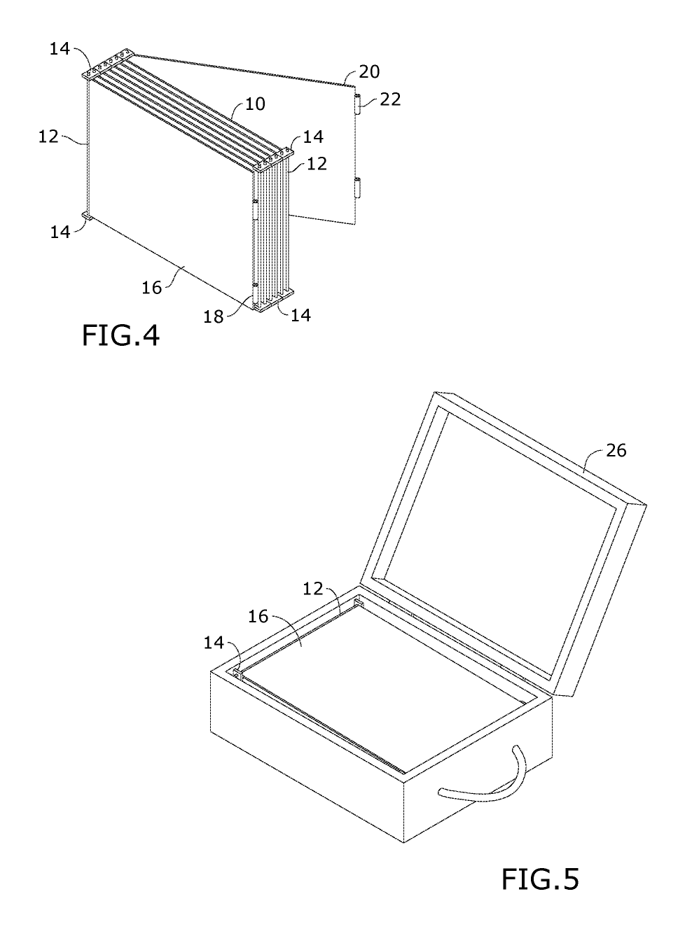

When not in use, the fire ring 30 may be disassembled so that the plurality of member plate sections 10 and first and second end plate section 16 and 20 may be moved, folded or collapsed to the storage configuration, typically a stacked arrangement, as illustrated in FIGS. 4 and 5, where the plurality of rod connectors 14 are still engaging adjacent rods 12. In the storage configuration, the fire ring 30 may be placed within a storage box 26 provided by the present invention, as illustrated in FIG. 5.

A method of using the present invention may include the following. The portable fire ring 30 disclosed above may be provided. For surrounding a campfire or area along a supporting surface, a user may assemble and connect the plurality plate sections 10, 16 and 20 together in an end-to-end relationship to form or fold into a various geometrically shaped fire rings by way of sliding each of the plurality of connectors 14 onto adjacent rods 12 and rotated the plate sections accordingly. The desired geometrical shape fire ring may be closed by way of engagement of the nested first and second end plate section sleeves 18 and 22 and engaged via the connecting rod 24. When such operable configuration is no longer needed, the fire ring 30 may be folded into the storage configuration without removing the plurality of connectors 14; rather just removing the connecting rod 24, and then stored if desired in the storage box 26. Furthermore, from such a storage configuration, the portable fire ring 30 may be unfolded into another desired geometrically shaped fire ring without addressing the already engaged connectors 14.

It should be understood, of course, that the foregoing relates to exemplary embodiments of the invention and that modifications may be made without departing from the spirit and scope of the invention as set forth in the following claims.

1. A portable fire ring, comprising:
at least two substantially identical member plate sections, each member plate section having a member body defined by a member upper edge, a member lower edge and opposing member ends, each member end providing a member rod having opposing termini extending beyond the member upper and lower edges, respectively; and
a plurality of connectors providing at least two spaced apart holes, each hole dimensioned to snugly, removably and slidably receive a terminus therethrough,
whereby the member rods rotatably engage respective holes so that the portable fire ring is foldable between an operable configuration and a storage configuration wherein the member bodies are coextensively stacked.

2. The portable fire ring of claim 1, wherein the member plate sections are made of fire resistant material.

3. The portable fire ring of claim 1, further comprising:
a first end plate section having a first body defined by a first upper edge, a first lower edge and opposing first rod end and sleeve ends, the first rod end providing a first rod having opposing termini extending beyond the first upper and lower edges, the sleeve end providing at least one first sleeve; and
a second end plate section having a second body defined by a second upper edge, a second lower edge and opposing second rod end and sleeve ends, the second rod end providing a second rod having opposing termini extending beyond the second upper and lower edges, the second sleeve end providing at least one second sleeve, wherein the at least first and second sleeves are aligned and spaced apart in the operable configuration; and
a connecting rod dimensioned to removably be received through the at least first and second sleeves in the operable configuration.

4. The portable fire ring of claim 3, wherein the plate sections are made of fire resistant material.

5. The portable fire ring of claim 3, wherein the operable configuration is moveable to a plurality of geometric shapes include rectangular and hexagonal shapes.

6. The portable fire ring of claim 3, wherein the connecting rod is L-shaped.

7. A portable fire ring system, comprising:
a portable fire ring comprising:
at least two substantially identical member plate sections, each member plate section having a member body defined by a member upper edge, a member lower edge and opposing member ends, each member end providing a member rod having opposing termini extending beyond the member upper and lower edges, respectively;
a first end plate section having a first body defined by a first upper edge, a first lower edge and opposing first rod end and sleeve ends, the first rod end providing a first rod having opposing termini extending beyond the first upper and lower edges, the sleeve end providing at least one first sleeve;
a second end plate section having a second body defined by a second upper edge, a second lower edge and opposing second rod end and sleeve ends, the second rod end providing a second rod having opposing termini extending beyond the second upper and lower edges, the second sleeve end providing at least one second sleeve, wherein the at least first and second sleeves are aligned and spaced apart in the operable configuration;
a plurality of connectors providing at least two spaced apart holes, each hole dimensioned to snugly, removably and slidably receive a terminus therethrough, wherein each rod rotatably engages the respective hole so that the portable fire ring is foldable between an operable configuration and a storage configuration wherein the member bodies are coextensively stacked; and
a connecting rod dimensioned to removably be received through the at least first and second sleeves in the operable configuration; and
a storage box dimensioned to snugly receive the storage configuration.

8. The system of claim 7, wherein the connecting rod is L-shaped.

9. The system of claim 7, wherein the plate sections are made of fire resistant material.
